(19) United States
(12) Patent Application Publication
(10) Pub. No.: US 2023/0125078 A1
(43) Pub. Date: Apr. 27, 2023

(54) ENHANCED SIGNALING OF ADDITION AND DELETION OF COMMUNICATION LINKS FOR MULTI-LINK DEVICES

(71) Applicants: Po-Kai Huang, San Jose, CA (US); Ido Ouzieli, Tel Aviv (IL); Danny Alexander, Neve Efraim Monoson (IL); Daniel Bravo, Portland, OR (US); Laurent Cariou, Milizac (FR)

(72) Inventors: Po-Kai Huang, San Jose, CA (US); Ido Ouzieli, Tel Aviv (IL); Danny Alexander, Neve Efraim Monoson (IL); Daniel Bravo, Portland, OR (US); Laurent Cariou, Milizac (FR)

(21) Appl. No.: 18/145,710

(22) Filed: Dec. 22, 2022

Related U.S. Application Data
(60) Provisional application No. 63/356,903, filed on Jun. 29, 2022.

(51) Int. Cl. H04W 76/15; H04W 76/30

(52) U.S. Cl. CPC H04W 76/15; H04W 76/30

(57) ABSTRACT

This disclosure describes systems, methods, and devices related to adding or removing communication access points (APs) affiliated with an associated AP multi-link device (AP-MLD). A non-AP-MLD may identify a communication link between the non-AP-MLD and an AP-MLD, the communication link previously used by the non-AP-MLD; encode a request frame comprising a multi-link reconfiguration element indicative of a request to add or remove the communication link; cause the non-AP-MLD to transmit the request frame to the AP-MLD; and identify a response frame received from the AP-MLD, the response frame comprising the multi-link reconfiguration element and indicating whether the communication link was accepted or rejected to be added or removed.

### CROSS-REFERENCE TO RELATED PATENT APPLICATION(S)

This application claims the benefit of U.S. Provisional Application No. 63/356,903, filed Jun. 29, 2022, the disclosure of which is incorporated by reference as set forth in full.

### TECHNICAL FIELD

This disclosure generally relates to systems and methods for wireless communications and, more particularly, to signaling the addition and deletion of communication links used by multi-link devices.

### BACKGROUND

Wireless devices are becoming widely prevalent and are increasingly requesting access to wireless channels. The Institute of Electrical and Electronics Engineers (IEEE) is developing one or more standards that utilize Orthogonal Frequency-Division Multiple Access (OFDMA) in channel allocation.

### BRIEF DESCRIPTION OF THE DRAWINGS

FIG. 1A is a network diagram illustrating an example network environment, in accordance with one or more example embodiments of the present disclosure.

FIG. 1B depicts an illustrative schematic diagram for multi-link device (MLD) communications between two logical entities, in accordance with one or more example embodiments of the present disclosure.

FIG. 1C depicts an illustrative schematic diagram for MLD communications between an access point (AP) MLD with logical entities and a non-AP MLD with logical entities, in accordance with one or more example embodiments of the present disclosure.

FIG. 2 illustrates a flow diagram of illustrative process for signaling of added and/or deleted communication link reconfiguration between MLDs, in accordance with one or more example embodiments of the present disclosure.

FIG. 3 illustrates a functional diagram of an exemplary communication station that may be suitable for use as a user device, in accordance with one or more example embodiments of the present disclosure.

FIG. 4 illustrates a block diagram of an example machine upon which any of one or more techniques (e.g., methods) may be performed, in accordance with one or more example embodiments of the present disclosure.

FIG. 5 is a block diagram of a radio architecture in accordance with some examples.

FIG. 6 illustrates an example front-end module circuitry for use in the radio architecture of FIG. 5, in accordance with one or more example embodiments of the present disclosure.

FIG. 7 illustrates an example radio IC circuitry for use in the radio architecture of FIG. 5, in accordance with one or more example embodiments of the present disclosure.

FIG. 8 illustrates an example baseband processing circuitry for use in the radio architecture of FIG. 5, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

The IEEE 802.11 technical standards define communications for Wi-Fi, including multi-link devices (MLDs). A MLD is a logical entity that contains one or more station devices (STAs). The logical entity has one medium access control (MAC) data service interface and primitives to the logical link control (LLC), and a single address associated with the interface, which can be used to communicate on the distribution system medium (DSM). A MLD may allow multiple STAs within the MLD to have a same MAC address. In an infrastructure framework, there may be an MLD whose logical entities are APs (e.g., an A-MLD) on one side, and a MLD on the other side (e.g., a non-AP MLD, referring to a MLD whose logical entities are non-AP STAs). For example, an A-MLD (or AP MLD) may refer to a MLD in which each STA in (e.g., affiliated with the MLD) the AP MLD is an extremely high throughput (EHT) AP, and a MLD (non-AP MLD) may refer to a MLD whose STAs within (e.g., affiliated with) the MLD are non-AP EHT STAs.

In 802.11 MLD reconfiguration, an AP MLD may reconfigure a setting by adding back any affiliated APs at any time through an indication in a beacon or probe response frame. An AP MLD may remove any affiliated AP, which may be announced using a reconfiguration multi-link element with a delete timer such that when the delete timer expires, the information of the removed AP may be deleted by the non-AP MLD. The format of the 802.11 multi-link element is shown below in Table 1.

TABLE 1
Format of 802.11 Multi-Link Element

| | Element | | Element ID | Multi-Link | Common | Link |
|---|---|---|---|---|---|---|
| Field: | ID | Length | Extension | Control | Info | Info |
| Octets: | 1 | 1 | 1 | 2 | Variable | Variable |

The format of the 802.11 multi-link control field of Table 1 is shown below in Table 2:

TABLE 2
Format of 802.11 Multi-Link Control Field

| Field: | Type | Reserved | Presence Bitmap |
|---|---|---|---|
| Bits: | 3 | 1 | 12 |

The format of the 802.11 type subfield of Table 2 is shown below in Table 3:

TABLE 3
Format of 802.11 Type subfield

| Type Subfield Value | Multi-Link Element Variant Name |
|---|---|
| 0 | Basic |
| 1 | Probe Request |
| 2 | Reconfiguration |
| 3 | Tunneled Direct Link Setup (TDLS) |
| 4 | Priority Access |
| 5-7 | Reserved |

The format of the presence bitmap of Table 2 is specific for each variant in Table 3, which indicates whether a specific field is present in the common info field of Table 1. The format of the Link Info field of Table 1 is shown below in Table 4:

TABLE 4
Format of 802.11 Link Info Field

| Subelement ID | Name | Extensible |
|---|---|---|
| 0 | Per-STA Profile | Yes |
| 1-220 | Reserved | |
| 221 | Vendor Specific | Vendor defined |
| 222-253 | Reserved | |
| 254 | Fragment | No |
| 255 | Reserved | |

When an AP MLD removes an affiliated AP and adds the AP back (e.g., for a maintenance reason), a non-AP MLD must perform 802.11 reassociation to add back the link to the removed AP. For example, when there are three links of an MLD and one link is removed, the MLD has two active links. Later, the corresponding AP is added back by an AP MLD, so the non-AP MLD has to perform reassociation with the same AP MLD to add back the link. This implies re-performing various negotiations like association exchange, four-way handshake, block acknowledgement negotiation, target wake time (TWT), and the like on each link of the non-AP MLD.

To address this problem, existing proposals to use a frame exchange to add one or more links to an MLD lack signaling details such as a specific request and response frame. For example:
The added link needs to have GTK/IGTK/BIGTK and corresponding key information, which is traditionally delivered in 4-way handshake using KDE (key data encapsulation).
Channel validation needs to be done because the client may add the link based on wrong discovery information.
Only some of the added link maybe accepted by the AP MLD. There is a need to define granularity for acceptance and rejection of requested links.
The information for each link is likely to be carried in a Per-STA profile of the multi-link element. The Per-STA profile will have complete profile and will likely include some fields in (re)association request/response but not all.
   a. For example, Capability Information/status code/Supported Rates and BSS membership Selectors fields in (re)association response frame are needed
   b. For example, AID field in (re)association response frame are not needed since AID is common for non-AP MLD
   c. For example, Capability Information field in (re)association request are needed.
   d. For example, Current AP address field in reassociation request is not needed.

Specific fields and element order, or mapping to either an association request/response frame or reassociation request/response frame, need to be defined specifically.

The complete profile of a reported STA consists of all the elements and fields (subject to exceptions below) that would be included in a Management frame, that is of the same subtype as that transmitted by the reporting STA carrying the Basic Multi-Link element, if the reported STA were to transmit the frame.

Some information in MLD Capabilities and Operations may need to be updated, and some may not need to change. For example, it may be determined how to properly indicate the value.

For example, Maximum Number Of Simultaneous Links for non-AP MLD. Frequency Separation For STR/AP MLD Type Indication for non-AP MLD.

For example, SRS support does not need to change.

How TID-to-link mapping is handled in the new added link may be defined.

It may be determined whether, by default, all traffic identifiers (TIDs) should be mapped to the new link.

It may be determined how default power save is defined.

It may be determined whether there should be, by default, a power save (PS) mode and doze state.

The 802.11 non-simultaneous transmission reception (NSTR) operation needs to be carefully updated.

When a link is deleted, its NSTR status with other links is removed.

However, when a link is added back (e.g., with the same link ID), its NSTR status with other links maybe updated.

For example, if link 1 indicates it is NSTR with link 2, and link 2 indicates it is NSTR with link 1. If link 2 is deleted and added back, the NSTR status has to depend on the newly added NSTR status by link 2 with other links.

In one or more embodiments, the present disclosure provides detailed signaling for an added link operation for MLDs, and provides for how to add a link back using a non-AP MLD in a single operation. The deleted and added link may be a same link or different links. Currently, the multi-link reconfiguration operation is only initiated by an AP in 802.11 (e.g., the AP may add or delete a link). The enhanced multi-link reconfiguration operations herein allow for a non-AP MLD to initiate (e.g., request) the reconfiguration of adding or deleting a previously used link.

In one or more embodiments, the signaling of a request/response frame to add a link initiated by a non-AP MLD is provided herein. The present disclosure may define the request/response frame to be a protected action frame, and may define the signaling to include a KDE in the request/response frame. Option 1 includes a KDE container element to include KDE selector normally included in the 802.11 4-way handshake. The format is shown below in Table 5:

TABLE 5
KDE Container Element Format

| | | | Element ID | One or more |
|---|---|---|---|---|
| Field: | Element ID | Length | Extension | KDE |
| Octets: | 1 | 1 | 1 | Variable |

The KDE format is shown below in Table 6:

TABLE 6
KDE Container Element Format

| | Type | | | | |
|---|---|---|---|---|---|
| Field: | (0 × dd) | Length | OUI | Data Type | Data |
| Octets: | 1 | 1 | 3 | 1 | (Length-4) |

The multi-link operation (MLO) OCI KDE may be defined as shown below in Table 7:

TABLE 7
MLO OCI KDE Container Element Format

| | | | Channel | | |
|---|---|---|---|---|---|
| | | | Center | | |
| | | | Frequency | | |
| | | Primary | Segment | | |
| | Operating | Channel | Channel | | |
| Field: | Class | Number | Number | Link ID | Reserved |
| Bits: | 8 | 8 | 8 | 4 | 4 |

In one or more embodiments, the Operating Class field is defined in OCI element.

In one or more embodiments, the Primary Channel Number field is as defined in OCI element.

In one or more embodiments, the Channel center frequency segment channel number field indicates for 20, 40, 80, 160, or 320 MHz EHT dBSS band width, the channel center frequency index for the 20, 40, 80, 160, 320 MHz channel on which the EHT BSS operates.

In one or more embodiments, the channel center frequency segment channel number field indicates for 320 MHz BSS band width, the channel center frequency index for the 320 MHz channel on which the EHT BSS operates. Otherwise the field is set to 0.

In one or more embodiments, the Link ID field contains the link identifier that corresponds to the link this operating channel information applies.

In one or more embodiments, option 2 for the request/response frame may be to include the key data length and key data field in the request and response frame as shown below in Table 8:

TABLE 8
KDE Container Element Format

| Field: | Key Data Length | Key Data |
|---|---|---|
| Octets: | 2 | Variable |

In one or more embodiments, the key data length field is the length of the key data field. When management frame protection is not used, the key data length field is zero. The key data field includes zero or more sub-elements with a format as shown below in Table 9:

TABLE 9
Optional Sub-Element Identifiers of Key Data Field

| Value | Content of Sub-Element |
|---|---|
| 0 | MLO GTK |
| 1 | MLO IGTK |
| 2 | MLO BIGTK |
| 3 | MLO OCI |

In one or more embodiments, MLO group temporal key (GTK) has the same format as WNM Sleep Mode MLO GTK subelement format.

In one or more embodiments, MLO integrity GTK (IGTK) has the same format as WNM Sleep Mode MLO IGTK subelement format.

In one or more embodiments, MLO BIGTK has the same format as WNM Sleep Mode MLO beacon IGTK (BIGTK) subelement format.

In one or more embodiments, MLO OCI has the following format as shown below in Table 10. The definition of the field is described above.

TABLE 10
MLO OCI Format

| | | | | | | | Channel |
|---|---|---|---|---|---|---|---|
| | | | | | | | Center |
| | | | | | | Primary | Frequency |
| | Subelement | | Link | | Operating | Channel | Segment |
| Field: | ID | Length | ID | Reserved | Class | Number | Number |
| Bits: | 8 | 8 | 4 | 4 | 8 | 8 | 8 |

In one or more embodiments, in the request frame, including the KDE-related information, the following may be applicable:
Including MLO OCI KDE related information for each link that are requested to add if OCV is supported for both AP MLD and non-AP MLD.
Does not need to include RSNE/RSNXE because they are the same for all links.
Does not need to include MAC address KDE verify MLD MAC address.
Does not need to include MLO link KDE to verify MAC address of specific link because the MAC address will be provided in the following elements.

In one or more embodiments, in the request frame, including the multi-link reconfiguration element, the following may apply:
The presence bitmap subfield and common info field for the multi-link reconfiguration element may be as shown below.

TABLE 11
Presence Bitmap Subfield of Reconfiguration Multi-Link Element

| | MLD MAC | |
|---|---|---|
| Field: | Address Present | Reserved |
| Bits: | 1 | 11 |

TABLE 12
Common Info Field of Reconfiguration Multi-Link Element

| Field: | MLD MAC Address |
|---|---|
| Bits: | 0 or 6 |

In one or more embodiments, MLD capabilities and operations may be present in the presence bitmap subfield by having the field set to 1. The presence bitmap subfield may indicate a Maximum Number Of Simultaneous Links in MLD Capabilities and Operations included in Common Info field. The Maximum Number Of Simultaneous Links is as defined in basic multi-link element. Indicate Frequency Separation For STR/AP MLD Type Indication in MLD Capabilities and Operations included in Common Info field. Frequency Separation For STR/AP MLD Type Indication is as defined in basic multi-link element. This is useful for adding a link to increase the number of setup links from one to two.

In one or more embodiments, the enhanced multi-link (EML) capabilities may be present and set to 1 or 0 based on the implementation. The per-STA profile subelement and STA control for multi-link reconfiguration element are defined below.

TABLE 13
Per-STA Profile Subelement for Reconfiguration
Multi-Link Element

| | | | STA | | |
|---|---|---|---|---|---|
| Field: | Subelement ID | Length | Control | STA Info | STA Profile |
| Octets: | 1 | 1 | 2 | Variable | Variable |

TABLE 14
STA Control Field Format for Reconfiguration Multi-Link Element

| | | | MAC | Delete | |
|---|---|---|---|---|---|
| | | Complete | Address | Timer | |
| Field: | Link ID | Profile | Present | Present | Reserved |
| Bits: | 4 | 1 | 1 | 1 | 9 |

In one or more embodiments, a NSTR link pair may be present in the STA control and set to 1, indicating that the NSTR indication bitmap subfield is present in the STA info. The NSTR bitmap size may be included in the STA control. The complete profile may be set to 1. The MAC address present may be set to 1, indicating that the STA MACK address subfield is present in the STA info. The STA profile may include fields followed by elements defined as follows: a capability information field defined in a (re)association request frame, and elements that may be present if sent in an association request frame, except RSNE and RSNXE, which are the same for all links of an MLD. The OCI element may be redefined by changing the frequency segment. One channel number to channel center frequency segment channel number may be defined as above, such as for 320 MHz, but can be 0 if 320 MHz is not used. The OCI element may be excluded if MLO OCI KDE is used. An inheritance rule may be defined based on the elements in the first STA profile in the multi-link reconfiguration element.

In one or more embodiments, for an AP MLD that receives the request frame, if OCV is supported, the AP MLD may verify MLO OCI KDE-related information or an OCI element, depending on the options for the operating class, primary channel number, and/or channel center frequency segment channel number. The AP MLD may reject the requested link if the verification fails, and may reject a requested link to be added if conditions do no match as defined in the multi-link setup to reject a link.

In one or more embodiments, in the response frame, the multi-link reconfiguration element may be included. For the field in STA control, the complete profile may be set to 1, and the MAC address present may be set to 1. A beacon interval present may be included the STA control and set to 1 to indicate that a beacon interval subfield is included in the STA info. A TSF offset present may be included in the STA control and set to 1 to indicate that the TSF offset subfield is present in the STA info. A deliver traffic indication map (DTIM) info present may be included in the STA control and set to 1 to indicate that a DTIM info subfield is present in the STA info. A basic service set (BSS) parameters change count present may be included in the STA info and set to 1 to indicate that a BSS parameters change count subfield is present in the STA info. A medium synchronization delay information present may be included in the STA info to indicate whether it is present or not.

In one or more embodiments, the STA profile may include fields followed by elements defined as follows. A capability information field defined in a (re)association response frame, a status code field defined in a (re)association response frame (e.g., indicating success if the link is accepted to be added or reasons that the link to be added has been rejected). A supported rates and BSS membership selectors field may be included as defined in a (re)association request frame. Elements that may be present if sent in an association response frame may include redefining the OCI element by changing the frequency segment 1 channel number to channel center frequency segment channel number as defined above. This is for 320 MHz, but can be 0 if 320 MHz is not used. The OCI element may be excluded if a MLO OCI KDE is used. An inheritance rule may be defined based on the elements of the first STA profile in the multi-link reconfiguration element.

In one or more embodiments, in the response frame, the KDE-related information may be included, including MLO OCI KDE-related information for each link that has been accepted to add if OCV is supported by both the AP MLD and the MLD. MLO GTK KDE-related information, MLO IGTK KDE-related information, and/or MLO BIGTK KDE-related information may be included for each link that are accepted to add. A MLO link KDE may not need to be included because the MAC address of the STA, RSNE, and RSNXE may be included in the per-STA profile of the multi-link reconfiguration element. A MAC address KDE may not need to be included because the MLD MAC address of the AP MLD may not change.

In one or more embodiments, when a non-AP MLD receives a response frame, if OCV is supported, the non-AP MLD may verify MLO OCI KDE-related information or an OCI element depending on the options for the operating class, primary channel number, and/or channel center frequency segment channel number. The link may not be added if the verification fails, and may be added if the link is accepted.

In one or more embodiments, for an AP MLD and non-AP MLD, the all TIDs mapped to the accepted links to be added may be defined by default unless a TID-to-Link mapping negotiation is embedded in the request/response frame exchange. The non-AP STA corresponding to the added links may be defined by default in a PS mode and doze state. The state machine of the non-AP and the AP corresponding to an added link may be in state 4 of state variables defined by 802.11 for STA authentication and association. The request and response frames intended for the MLDs may be defined, and the allowed to be sent in any setup link.

In one or more embodiments, link deletion, including for some links with simultaneous addition for some links, may be defined. A protected action frame may be defined to include the reconfiguration multi-link element for link addition or deletion initiated by the non-AP MLD. The frame intended for the MLD may be defined and allowed to be sent in any setup link. All requested links to be added or deleted may be included in a single reconfiguration multi-link element. A complete profile of STTA control in each per-STA profile may be set to zero. There may be no common info field, no STA info in each per-STA profile, and no STA profile in each per-STA profile. There may be one bit (e.g., in multi-link control or common info) to indicate a request to add a link. One option is to have the bit in STA control. Another option is to have the bit in the presence bitmap. Another option is to have the reconfiguration control present indicator in the presence bitmap, including the reconfiguration control in the common info field and a bit in the reconfiguration control to indicate link addition. For deletion, one bit in the multi-link control or common info may be used to indicate link deletion. The bit may be in STA control, the presence bitmap, or the reconfiguration control present may be in the presence bitmap with the reconfiguration control in the common info field and one bit in the reconfiguration control to indicate add/delete.

In one or more embodiments, for link addition, the request frame for link addition may be reused. For link deletion, the request frame for link addition may be reused, or an additional action frame may be defined. There may not be a need for the AP-MLD to confirm the request of link deletion. Once the AP-MLD receives the frame and sends the ACK, the link is deleted, for example.

In one or more embodiments, for link addition, the link suggestion frame may be defined to include a link suggested to be added. The multi-link reconfiguration element and link suggested to be included may be in the per-STA profile, and included in one reconfiguration multi-link element. Information for the suggested link may be added as elements. Information such as MLO GTK/IGTK/BIGTK-related information may not be included for security reasons. If a non-AP MLD is trying to add a suggested link, the non-AP MLD may continue with the request/response procedure as defined above.

In one or more embodiments, for link deletion, the link suggestion frame may be defined to include a link suggested to be deleted. The multi-link reconfiguration element may be included with a delete timer. The complete profile of STA control in each per-STA may be set to zero. No common info may be included, and no STA info or STA profile may be included in each per-STA profile. The suggested frame may be reused, or a new action frame may be defined for suggesting a link addition/deletion. One bit in the multi-link control or common info may indicate a link suggested to be added, and one bit in the multi-link control or common info field may indicate a link suggested to be deleted.

In one or more embodiments, between an AP MLD and a non-AP MLD associated with the AP MLD, the following individually addressed MMPDUs shall be intended for an MLD:
Authentication frame that includes a Basic Multi-Link element
(Re)Association Request/Response frame that includes a Basic Multi-Link element
Deauthentication frame
Disassociation frame
Block Ack Action frame
SA Query Action frame
Multi-link probe request/response
WNM Sleep Mode Request/Response frame
TID-To-Link Mapping Request/Response/Teardown frame
EPCS Priority Access Enable Request/Enable Response/Teardown frame
EML Operating Mode Notification frame
SCS Request/Response frame
MSCS Request/Response frame
ML Reconfiguration Request/Response frame.

In one or more embodiments, a single ML reconfiguration request supports indicating both addition and deletion of links to the ML setup. The AP MLD may accept the request partially or fully and it indicates the status accordingly in the response frame. The ML reconfiguration response provides GTK/IGTK/BIGTK (as applicable) for any newly added links to the ML setup. The MLO KDEs for GTK/IGTK/BIGTK are sent in the response frame. This proposal ensures that no additional message exchanges are needed to establish group keys for the newly added links. The ML Reconfiguration Request/Response exchange are done as protected action frame to deliver the group keys encrypted. Support for protected management frame is only required for EHT AP in current 11be draft text. For this feature, it is proposed to mandate the support for protected management frame for the EHT STAs as well. The ML Reconfiguration Request frame is an Action frame of category Protected EHT. The ML Reconfiguration Response frame is sent by an AP MLD in response to an ML Reconfiguration Request frame received from a non-AP MLD to accept or reject request for adding and/or deleting links to the multi-link setup of the non-AP MLD. The ML Reconfiguration Response frame is an Action frame of category Protected EHT.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

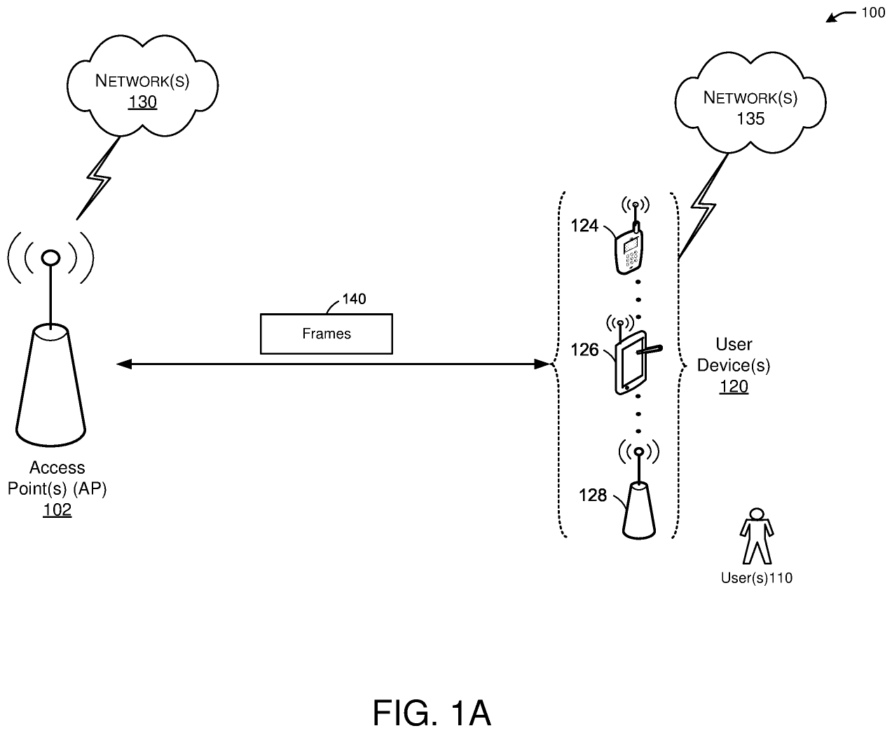

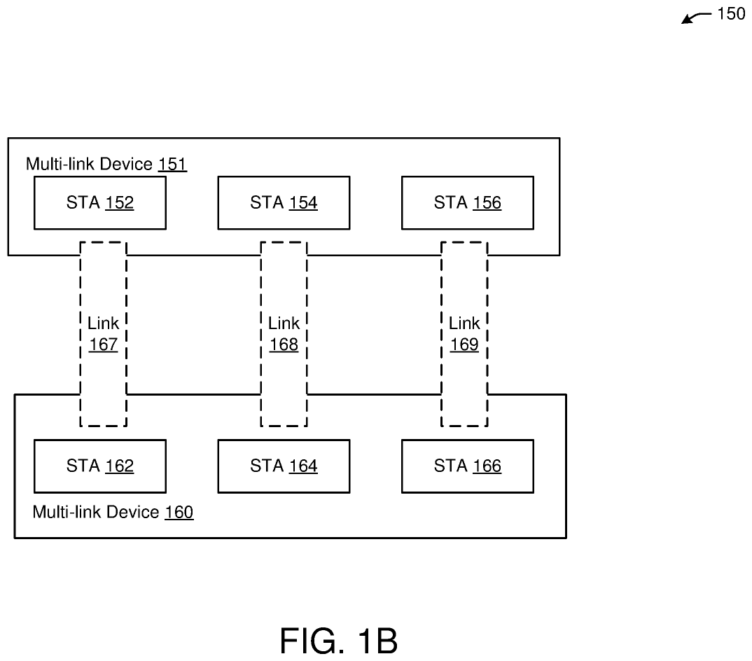

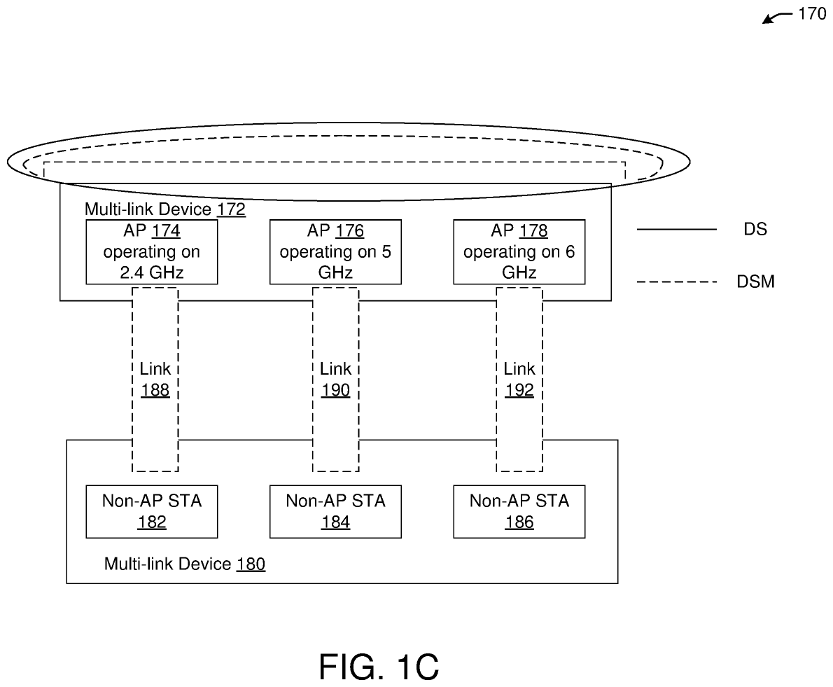

FIG. 1A is a network diagram illustrating an example network environment, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

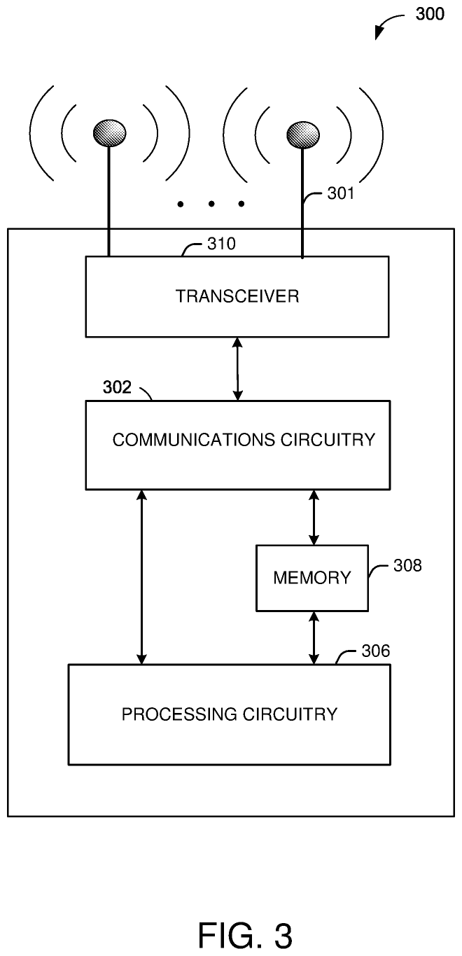

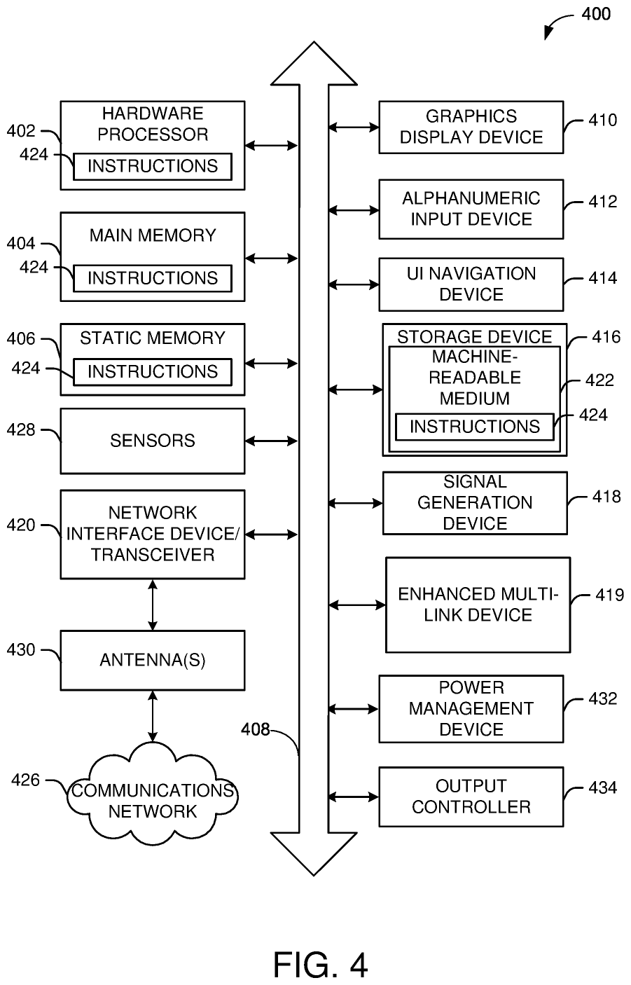

In some embodiments, the user devices 120 and the AP 102 may include one or more computer systems similar to that of the functional diagram of FIG. 3 and/or the example machine/system of FIG. 4.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, etc.), 6 GHz channels (e.g., 802.11ax, 802.11be, etc.), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1A, a user device 120 may be in communication with one or more APs 102. For example, one or more APs 102 may exchange frames 140 with one or more user devices 120. The frames 140 may include any frames associated with adding back and/or deleting any communication links with which the one or more APs 102 and/or the one or more user devices 120 may have been affiliated. In this manner, the frames 140 may include request/response frames with a multi-link reconfiguration element. The frames 140 may be protected frames (e.g., protected action frames). The one or more APs 102 may be AP MLDs, and the one or more user devices 120 may be non-AP MLDs (e.g., see FIGS. 1B and 1C), and the links requested to be added/deleted by the frames 140 may be one of multiple links used by the MLDs. The frames 140 also may indicate whether a requested link to be added or deleted was added or deleted.

It is understood that the above descriptions are for purposes of illustration and are not meant to be limiting.

FIG. 1B depicts an illustrative schematic diagram 150 for MLD communications between two logical entities, in accordance with one or more example embodiments of the present disclosure.

Referring to FIG. 1B, there are shown two MLDs in communication with each other. MLD 151 may include multiple STAs (e.g., STA 152, STA 154, STA 156, etc.), and MLD 160 may include multiple STAs (e.g., STA 162, STA 164, STA 166, etc.). The STAs of the MLD 151 and the STAs of the MLD 160 may set up links with each other (e.g., link 167 for a first frequency band used by the STA 152 and the STA 162, link 168 for a second frequency band used by the STA 154 and the STA 164, link 169 for a second frequency band used by the STA 156 and the STA 166). In this example of FIG. 1B, the two MLDs may be two separate physical devices, where each one comprises a number of virtual or logical devices (e.g., the STAs).

FIG. 1C depicts an illustrative schematic diagram 170 for MLD communications between an AP MLD with logical entities and a non-AP MLD with logical entities, in accordance with one or more example embodiments of the present disclosure.

Referring to FIG. 1C, there are shown two MLDs on either side, each which includes multiple STAs that can set up links with each other. For infrastructure framework, MLD 172 may be an A-MLD with logical APs (e.g., AP 174, AP 176, and AP 178) on one side, and MLD 180 may be a non-AP MLD including non-AP logical entities (non-AP STA 182, non-AP STA 184, and non-AP STA 186) on the other side. The detailed definition is shown below. It should be noted that the term MLLE and MLD are interchangeable and indicate the same type of entity. Throughout this disclosure, MLLE may be used but anywhere the MLLE term is used, it can be replaced with MLD. Multi-link non-AP logical entity (non-AP MLLE, also can be referred to as non-AP MLD): A multi-link logical entity, where each STA within the multi-link logical entity is a non-AP EHT STA. It should be noted that this framework is a natural extension from the one link operation between two STAs, which are AP and non-AP STA under the infrastructure framework (e.g., when an AP is used as a medium for communication between STAs).

In the example of FIG. 1C, the MLD 172 and the MLD 180 may be two separate physical devices, where each one comprises a number of virtual or logical devices. For example, the multi-link AP logical entity may comprise three APs, AP 174 operating on 2.4 GHz (e.g., link 188), AP 176 operating on 5 GHz (e.g., link 190), and AP 178 operating on 6 GHz (e.g., link 192). Further, the multi-link non-AP logical entity may comprise three non-AP STAs, non-AP STA 182 communicating with AP 174 on link 188, non-AP STA 184 communicating with AP 176 on link 190, and non-AP STA 186 communicating with AP 178 on link 192.

The MLD 172 is shown in FIG. 1C to have access to a distribution system (DS), which is a system used to interconnect a set of BSSs to create an extended service set (ESS). The MLD 172 is also shown in FIG. 1C to have access a distribution system medium (DSM), which is the medium used by a DS for BSS interconnections. Simply put, DS and DSM allow the AP to communicate with different BSSs.

It should be understood that although the example shows three logical entities within the MLD 172 and the three logical entities within the MLD 180, this is merely for illustration purposes and that other numbers of logical entities with each of the MLDs may be envisioned.

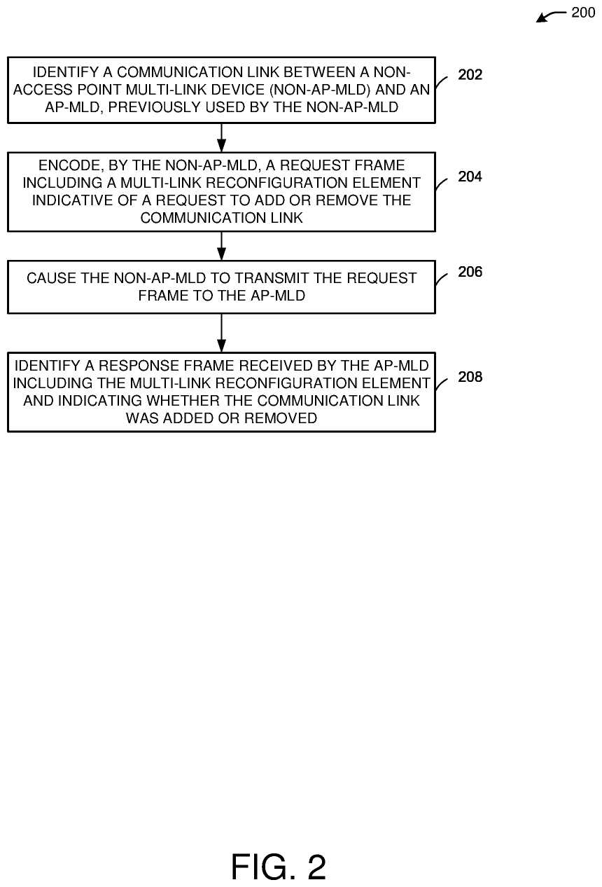

FIG. 2 illustrates a flow diagram of illustrative process for signaling of added and/or deleted communication link reconfiguration between MLDs, in accordance with one or more example embodiments of the present disclosure.

At block 202, a device (e.g., the user device(s) 120 of FIG. 1A, the MLD 151 or the MLD 160 of FIG. 1B, the MLD 180 of FIG. 1C, the enhanced multi-link device 419 of FIG. 4) may identify a communication link between the device (e.g., a non-AP-MLD device) and an AP-MLD, the link having been used previously by the non-AP-MLD.

At block 204, the device may encode a request frame including a multi-link reconfiguration element as defined above to request to remove or add the previously used communication link with the affiliated AP of the AP-MLD.

At block 206, the device may cause the non-AP MLD to transmit the request to the AP-MLD, which may receive and process the request by determining whether the requested link is to be added or removed as described above. In response, the AP-MLD may encode and transmit a response frame with the multi-link reconfiguration element to indicate whether the requested link was added or deleted as requested.

At block 208, the device may identify the response received from the AP-MLD.

It is understood that the above descriptions are for purposes of illustration and are not meant to be limiting.

FIG. 3 shows a functional diagram of an exemplary communication station 300, in accordance with one or more example embodiments of the present disclosure. In one embodiment, FIG. 3 illustrates a functional block diagram of a communication station that may be suitable for use as an AP 102 (FIG. 1A) or a user device 120 (FIG. 1A) in accordance with some embodiments. The communication station 300 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 300 may include communications circuitry 302 and a transceiver 310 for transmitting and receiving signals to and from other communication stations using one or more antennas 301. The communications circuitry 302 may include circuitry that can operate the physical layer (PHY) communications and/or medium access control (MAC) communications for controlling access to the wireless medium, and/or any other communications layers for transmitting and receiving signals. The communication station 300 may also include processing circuitry 306 and memory 308 arranged to perform the operations described herein. In some embodiments, the communications circuitry 302 and the processing circuitry 306 may be configured to perform operations detailed in the above figures, diagrams, and flows.

In accordance with some embodiments, the communications circuitry 302 may be arranged to contend for a wireless medium and configure frames or packets for communicating over the wireless medium. The communications circuitry 302 may be arranged to transmit and receive signals. The communications circuitry 302 may also include circuitry for modulation/demodulation, upconversion/downconversion, filtering, amplification, etc. In some embodiments, the processing circuitry 506 of the communication station 300 may include one or more processors. In other embodiments, two or more antennas 301 may be coupled to the communications circuitry 302 arranged for sending and receiving signals. The memory 308 may store information for configuring the processing circuitry 306 to perform operations for configuring and transmitting message frames and performing the various operations described herein. The memory 308 may include any type of memory, including non-transitory memory, for storing information in a form readable by a machine (e.g., a computer). For example, the memory 308 may include a computer-readable storage device, read-only memory (ROM), random-access memory (RAM), magnetic disk storage media, optical storage media, flash-memory devices and other storage devices and media.

In some embodiments, the communication station 300 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 300 may include one or more antennas 301. The antennas 301 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 300 may include one or more of a keyboard, a display, a non-volatile memory port, multiple antennas, a graphics processor, an application processor, speakers, and other mobile device elements. The display may be an LCD screen including a touch screen.

Although the communication station 300 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 300 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 300 may include one or more processors and may be configured with instructions stored on a computer-readable storage device.

FIG. 4 illustrates a block diagram of an example of a machine 400 or system upon which any one or more of the techniques (e.g., methodologies) discussed herein may be performed. In other embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environments. The machine 400 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The machine 400 may further include a power management device 432, a graphics display device 410, an alphanumeric input device 412 (e.g., a keyboard), and a user interface (UI) navigation device 414 (e.g., a mouse). In an example, the graphics display device 410, alphanumeric input device 412, and UI navigation device 414 may be a touch screen display. The machine 400 may additionally include a storage device (i.e., drive unit) 416, a signal generation device 418 (e.g., a speaker), an enhanced multi-link device 419, a network interface device/transceiver 420 coupled to antenna(s) 430, and one or more sensors 428, such as a global positioning system (GPS) sensor, a compass, an accelerometer, or other sensor. The machine 400 may include an output controller 434, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 402 for generation and processing of the baseband signals and for controlling operations of the main memory 404, the storage device 416, and/or the enhanced multi-link device 419. The baseband processor may be provided on a single radio card, a single chip, or an integrated circuit (IC).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within the static memory 406, or within the hardware processor 402 during execution thereof by the machine 400. In an example, one or any combination of the hardware processor 402, the main memory 404, the static memory 406, or the storage device 416 may constitute machine-readable media.

The enhanced multi-link device 419 may carry out or perform any of the operations and processes (e.g., process 200) described and shown above.

It is understood that the above are only a subset of what the enhanced multi-link device 419 may be configured to perform and that other functions included throughout this disclosure may also be performed by the enhanced multi-link device 419.

While the machine-readable medium 422 is illustrated as a single medium, the term “machine-readable medium” may include a single medium or multiple media (e.g., a centralized or distributed database, and/or associated caches and servers) configured to store the one or more instructions 424.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 400 and that cause the machine 400 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 424 may further be transmitted or received over a communications network 426 using a transmission medium via the network interface device/transceiver 420 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 420 may include one or more physical jacks (e.g., Ethernet, coaxial, or phone jacks) or one or more antennas to connect to the communications network 426. In an example, the network interface device/transceiver 420 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 400 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

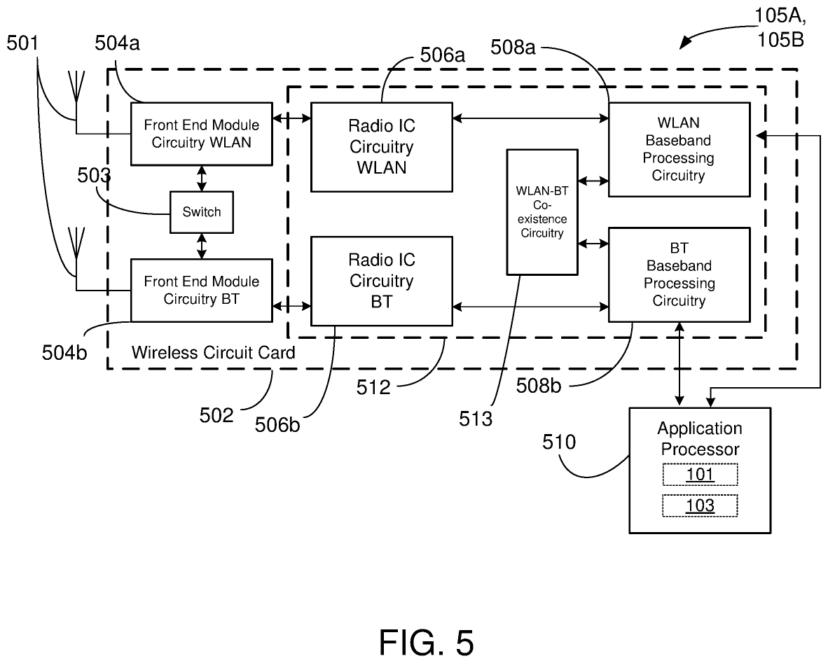

FIG. 5 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 504a-b, radio IC circuitry 506a-b and baseband processing circuitry 508a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 504a-b may include a WLAN or Wi-Fi FEM circuitry 504a and a Bluetooth (BT) FEM circuitry 504b. The WLAN FEM circuitry 504a may include a receive signal path comprising circuitry configured to operate on WLAN RF signals received from one or more antennas 501, to amplify the received signals and to provide the amplified versions of the received signals to the WLAN radio IC circuitry 506a for further processing. The BT FEM circuitry 504b may include a receive signal path which may include circuitry configured to operate on BT RF signals received from one or more antennas 501, to amplify the received signals and to provide the amplified versions of the received signals to the BT radio IC circuitry 506b for further processing. FEM circuitry 504a may also include a transmit signal path which may include circuitry configured to amplify WLAN signals provided by the radio IC circuitry 506a for wireless transmission by one or more of the antennas 501. In addition, FEM circuitry 504b may also include a transmit signal path which may include circuitry configured to amplify BT signals provided by the radio IC circuitry 506b for wireless transmission by the one or more antennas. In the embodiment of FIG. 5, although FEM 504a and FEM 504b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 506a-b as shown may include WLAN radio IC circuitry 506a and BT radio IC circuitry 506b. The WLAN radio IC circuitry 506a may include a receive signal path which may include circuitry to down-convert WLAN RF signals received from the FEM circuitry 504a and provide baseband signals to WLAN baseband processing circuitry 508a. BT radio IC circuitry 506b may in turn include a receive signal path which may include circuitry to down-convert BT RF signals received from the FEM circuitry 504b and provide baseband signals to BT baseband processing circuitry 508b. WLAN radio IC circuitry 506a may also include a transmit signal path which may include circuitry to up-convert WLAN baseband signals provided by the WLAN baseband processing circuitry 508a and provide WLAN RF output signals to the FEM circuitry 504a for subsequent wireless transmission by the one or more antennas 501. BT radio IC circuitry 506b may also include a transmit signal path which may include circuitry to up-convert BT baseband signals provided by the BT baseband processing circuitry 508b and provide BT RF output signals to the FEM circuitry 504b for subsequent wireless transmission by the one or more antennas 501. In the embodiment of FIG. 5, although radio IC circuitries 506a and 506b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 508a-b may include a WLAN baseband processing circuitry 508a and a BT baseband processing circuitry 508b. The WLAN baseband processing circuitry 508a may include a memory, such as, for example, a set of RAM arrays in a Fast Fourier Transform or Inverse Fast Fourier Transform block (not shown) of the WLAN baseband processing circuitry 508a. Each of the WLAN baseband circuitry 508a and the BT baseband circuitry 508b may further include one or more processors and control logic to process the signals received from the corresponding WLAN or BT receive signal path of the radio IC circuitry 506a-b, and to also generate corresponding WLAN or BT baseband signals for the transmit signal path of the radio IC circuitry 506a-b. Each of the baseband processing circuitries 508a and 508b may further include physical layer (PHY) and medium access control layer (MAC) circuitry, and may further interface with a device for generation and processing of the baseband signals and for controlling operations of the radio IC circuitry 506a-b.

Referring still to FIG. 5, according to the shown embodiment, WLAN-BT coexistence circuitry 513 may include logic providing an interface between the WLAN baseband circuitry 508a and the BT baseband circuitry 508b to enable use cases requiring WLAN and BT coexistence. In addition, a switch 503 may be provided between the WLAN FEM circuitry 504a and the BT FEM circuitry 504b to allow switching between the WLAN and BT radios according to application needs. In addition, although the antennas 501 are depicted as being respectively connected to the WLAN FEM circuitry 504a and the BT FEM circuitry 504b, embodiments include within their scope the sharing of one or more antennas as between the WLAN and BT FEMs, or the provision of more than one antenna connected to each of FEM 504a or 504b.

In some embodiments, the front-end module circuitry 504a-b, the radio IC circuitry 506a-b, and baseband processing circuitry 508a-b may be provided on a single radio card, such as wireless radio card 502. In some other embodiments, the one or more antennas 501, the FEM circuitry 504a-b and the radio IC circuitry 506a-b may be provided on a single radio card. In some other embodiments, the radio IC circuitry 506a-b and the baseband processing circuitry 508a-b may be provided on a single chip or integrated circuit (IC), such as IC 512.

In some embodiments, the wireless radio card 502 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11 ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 5, the BT baseband circuitry 508b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

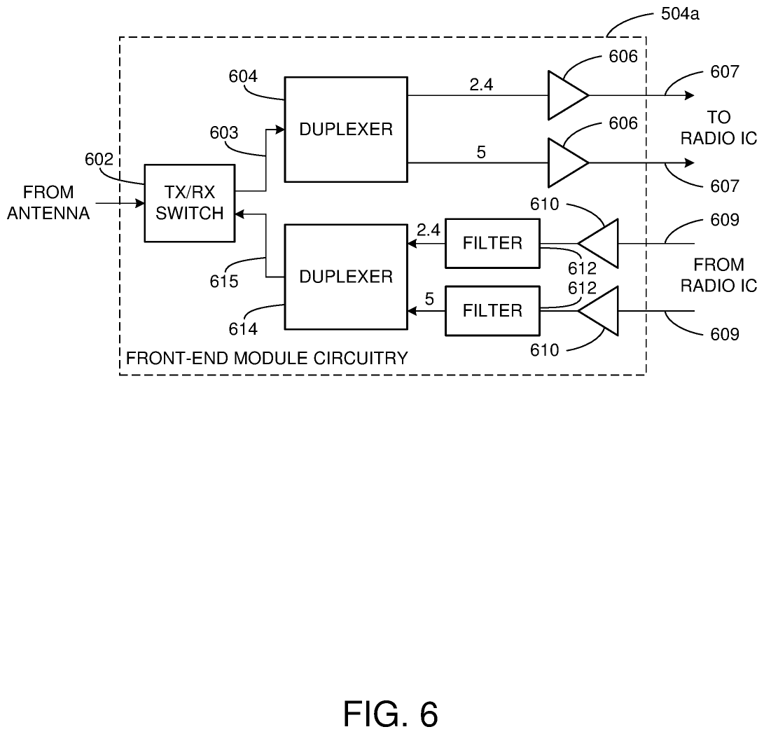

FIG. 6 illustrates WLAN FEM circuitry 504a in accordance with some embodiments. Although the example of FIG. 6 is described in conjunction with the WLAN FEM circuitry 504a, the example of FIG. 6 may be described in conjunction with the example BT FEM circuitry 504b (FIG. 5), although other circuitry configurations may also be suitable.

In some embodiments, the FEM circuitry 504a may include a TX/RX switch 602 to switch between transmit mode and receive mode operation. The FEM circuitry 504a may include a receive signal path and a transmit signal path. The receive signal path of the FEM circuitry 704a may include a low-noise amplifier (LNA) 606 to amplify received RF signals 603 and provide the amplified received RF signals 607 as an output (e.g., to the radio IC circuitry 506a-b (FIG. 5)). The transmit signal path of the circuitry 504a may include a power amplifier (PA) to amplify input RF signals 609 (e.g., provided by the radio IC circuitry 506a-b), and one or more filters 612, such as band-pass filters (BPFs), low-pass filters (LPFs) or other types of filters, to generate RF signals 615 for subsequent transmission (e.g., by one or more of the antennas 501 (FIG. 5)) via an example duplexer 614.

In some dual-mode embodiments for Wi-Fi communication, the FEM circuitry 504a may be configured to operate in either the 2.4 GHz frequency spectrum or the 5 GHz frequency spectrum. In these embodiments, the receive signal path of the FEM circuitry 504a may include a receive signal path duplexer 604 to separate the signals from each spectrum as well as provide a separate LNA 606 for each spectrum as shown. In these embodiments, the transmit signal path of the FEM circuitry 504a may also include a power amplifier 610 and a filter 612, such as a BPF, an LPF or another type of filter for each frequency spectrum and a transmit signal path duplexer 804 to provide the signals of one of the different spectrums onto a single transmit path for subsequent transmission by the one or more of the antennas 501 (FIG. 5). In some embodiments, BT communications may utilize the 2.4 GHz signal paths and may utilize the same FEM circuitry 504a as the one used for WLAN communications.

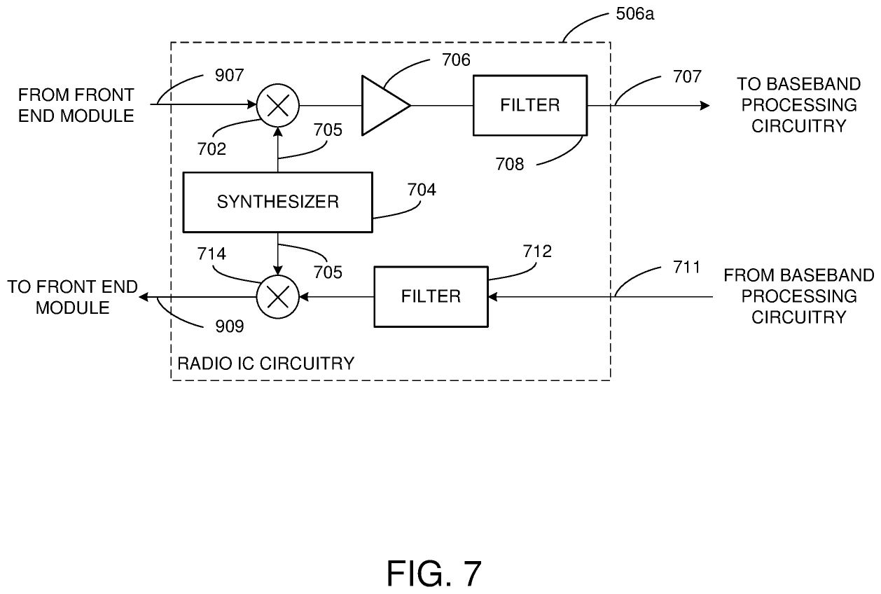

FIG. 7 illustrates radio IC circuitry 506a in accordance with some embodiments. The radio IC circuitry 506a is one example of circuitry that may be suitable for use as the WLAN or BT radio IC circuitry 506a/506b (FIG. 5), although other circuitry configurations may also be suitable. Alternatively, the example of FIG. 7 may be described in conjunction with the example BT radio IC circuitry 506b.

In some embodiments, the radio IC circuitry 506a may include a receive signal path and a transmit signal path. The receive signal path of the radio IC circuitry 506a may include at least mixer circuitry 702, such as, for example, down-conversion mixer circuitry, amplifier circuitry 706 and filter circuitry 708. The transmit signal path of the radio IC circuitry 506a may include at least filter circuitry 712 and mixer circuitry 714, such as, for example, up-conversion mixer circuitry. Radio IC circuitry 506a may also include synthesizer circuitry 704 for synthesizing a frequency 705 for use by the mixer circuitry 702 and the mixer circuitry 714. The mixer circuitry 702 and/or 714 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 7 illustrates only a simplified version of a radio IC circuitry, and may include, although not shown, embodiments where each of the depicted circuitries may include more than one component. For instance, mixer circuitry 714 may each include one or more mixers, and filter circuitries 708 and/or 712 may each include one or more filters, such as one or more BPFs and/or LPFs according to application needs. For example, when mixer circuitries are of the direct-conversion type, they may each include two or more mixers.

In some embodiments, mixer circuitry 702 may be configured to down-convert RF signals 607 received from the FEM circuitry 504a-b (FIG. 5) based on the synthesized frequency 705 provided by synthesizer circuitry 704. The amplifier circuitry 706 may be configured to amplify the down-converted signals and the filter circuitry 708 may include an LPF configured to remove unwanted signals from the down-converted signals to generate output baseband signals 707. Output baseband signals 707 may be provided to the baseband processing circuitry 508a-b (FIG. 5) for further processing. In some embodiments, the output baseband signals 707 may be zero-frequency baseband signals, although this is not a requirement. In some embodiments, mixer circuitry 702 may comprise passive mixers, although the scope of the embodiments is not limited in this respect.

In some embodiments, the mixer circuitry 714 may be configured to up-convert input baseband signals 711 based on the synthesized frequency 705 provided by the synthesizer circuitry 704 to generate RF output signals 609 for the FEM circuitry 504a-b. The baseband signals 711 may be provided by the baseband processing circuitry 508a-b and may be filtered by filter circuitry 712. The filter circuitry 712 may include an LPF or a BPF, although the scope of the embodiments is not limited in this respect.

In some embodiments, the mixer circuitry 702 and the mixer circuitry 714 may each include two or more mixers and may be arranged for quadrature down-conversion and/or up-conversion respectively with the help of synthesizer 704. In some embodiments, the mixer circuitry 702 and the mixer circuitry 714 may each include two or more mixers each configured for image rejection (e.g., Hartley image rejection). In some embodiments, the mixer circuitry 702 and the mixer circuitry 714 may be arranged for direct down-conversion and/or direct up-conversion, respectively. In some embodiments, the mixer circuitry 702 and the mixer circuitry 714 may be configured for super-heterodyne operation, although this is not a requirement.

Mixer circuitry 702 may comprise, according to one embodiment: quadrature passive mixers (e.g., for the in-phase (I) and quadrature phase (Q) paths). In such an embodiment, RF input signal 607 from FIG. 6 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 705 of synthesizer 704 (FIG. 7). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 607 (FIG. 6) may comprise a balanced signal, although the scope of the embodiments is not limited in this respect. The I and Q baseband output signals may be provided to low-noise amplifier, such as amplifier circuitry 706 (FIG. 7) or to filter circuitry 708 (FIG. 7).

In some embodiments, the output baseband signals 707 and the input baseband signals 711 may be analog baseband signals, although the scope of the embodiments is not limited in this respect. In some alternate embodiments, the output baseband signals 707 and the input baseband signals 711 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 704 may be a fractional-N synthesizer or a fractional N/N+1 synthesizer, although the scope of the embodiments is not limited in this respect as other types of frequency synthesizers may be suitable. For example, synthesizer circuitry 704 may be a delta-sigma synthesizer, a frequency multiplier, or a synthesizer comprising a phase-locked loop with a frequency divider. According to some embodiments, the synthesizer circuitry 704 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 704 may be provided by a voltage controlled oscillator (VCO), although that is not a requirement. A divider control input may further be provided by either the baseband processing circuitry 508a-b (FIG. 5) depending on the desired output frequency 705. In some embodiments, a divider control input (e.g., N) may be determined from a look-up table (e.g., within a Wi-Fi card) based on a channel number and a channel center frequency as determined or indicated by the example application processor 510. The application processor 510 may include, or otherwise be connected to, one of the example secure signal converter 101 or the example received signal converter 103 (e.g., depending on which device the example radio architecture is implemented in).

In some embodiments, synthesizer circuitry 704 may be configured to generate a carrier frequency as the output frequency 705, while in other embodiments, the output frequency 705 may be a fraction of the carrier frequency (e.g., one-half the carrier frequency, one-third the carrier frequency). In some embodiments, the output frequency 705 may be a LO frequency (fLO).

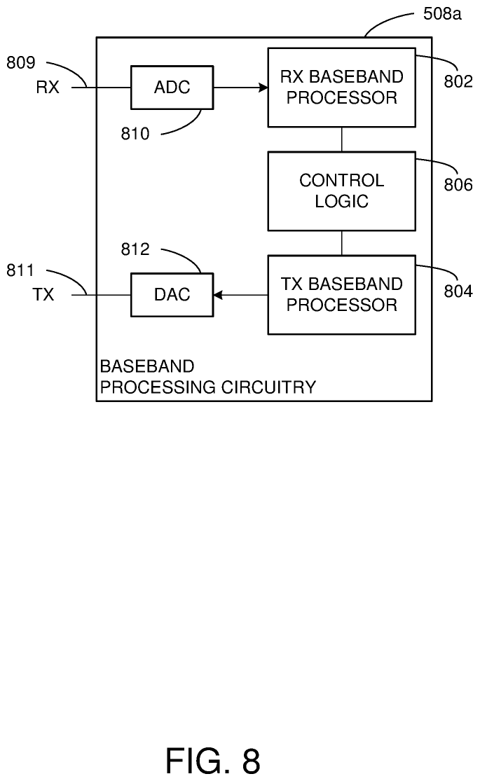

FIG. 8 illustrates a functional block diagram of baseband processing circuitry 708a in accordance with some embodiments. The baseband processing circuitry 508a is one example of circuitry that may be suitable for use as the baseband processing circuitry 508a (FIG. 5), although other circuitry configurations may also be suitable. Alternatively, the example of FIG. 7 may be used to implement the example BT baseband processing circuitry 508b of FIG. 5.

The baseband processing circuitry 508a may include a receive baseband processor (RX BBP) 802 for processing receive baseband signals 709 provided by the radio IC circuitry 506a-b (FIG. 5) and a transmit baseband processor (TX BBP) 804 for generating transmit baseband signals 711 for the radio IC circuitry 506a-b. The baseband processing circuitry 508a may also include control logic 806 for coordinating the operations of the baseband processing circuitry 508a.

In some embodiments (e.g., when analog baseband signals are exchanged between the baseband processing circuitry 508a-b and the radio IC circuitry 506a-b), the baseband processing circuitry 508a may include ADC 810 to convert analog baseband signals 809 received from the radio IC circuitry 506a-b to digital baseband signals for processing by the RX BBP 802. In these embodiments, the baseband processing circuitry 508a may also include DAC 812 to convert digital baseband signals from the TX BBP 804 to analog baseband signals 811.

In some embodiments that communicate OFDM signals or OFDMA signals, such as through baseband processor 508a, the transmit baseband processor 804 may be configured to generate OFDM or OFDMA signals as appropriate for transmission by performing an inverse fast Fourier transform (IFFT). The receive baseband processor 802 may be configured to process received OFDM signals or OFDMA signals by performing an FFT. In some embodiments, the receive baseband processor 802 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 5, in some embodiments, the antennas 501 (FIG. 5) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 501 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include an apparatus of a non-access point (AP) multi-link device (non-AP-MLD) for adding or removing communication APs affiliated with an associated AP MLD, the non-AP-MLD comprising processing circuitry coupled to storage, the processing circuitry configured to: identify a communication link between the non-AP-MLD and an AP-MLD, the communication link previously used by the non-AP-MLD; encode a request frame comprising a multi-link reconfiguration element indicative of a request to add or remove the communication link; cause the non-AP-MLD to transmit the request frame to the AP-MLD; and identify a response frame received from the AP-MLD, the response frame comprising the multi-link reconfiguration element and indicating whether the communication link was accepted or rejected to be added or removed.

Example 2 may include the apparatus of example 1 and/or any other example herein, wherein the request frame and the response frame are protected 802.11 action frames comprising one or more key data encapsulation (KDE), and comprising a key data length field and a key data field, wherein the key data length field is indicative of a length of the key data field and the key data field includes the one or more KDE.

Example 3 may include the apparatus of example 1 and/or any other example herein, wherein the multi-link reconfiguration element of the request frame comprises a MLD capabilities and operations present field set to one in a presence bitmap.

Example 4 may include the apparatus of example 1 and/or any other example herein, wherein the multi-link reconfiguration element of the request frame comprises an enhanced multi-link (EML) capabilities present field set to 1 or 0.

Example 5 may include the apparatus of example 1 and/or any other example herein, wherein the multi-link reconfiguration element of the request frame comprises a non-simultaneous transmission reception (NSTR) link pair present in a STA control field and is set to 1.

Example 6 may include the apparatus of example 1 and/or any other example herein, wherein the multi-link reconfiguration element of the request frame comprises a NSTR bitmap size field in a STA control field, wherein a complete profile field is set to 1, and wherein a medium access control (MAC) address present field is set to 1.

Example 7 may include the apparatus of example 1 and/or any other example herein, wherein the multi-link reconfiguration element of the request frame comprises a station (STA) profile field comprising a capability information field as defined in an 802.11 association request frame, and elements that will be present if sent in an 802.11 association request frame, and wherein an inheritance rule of the elements is based on the elements in the first STA profile field in the multi-link reconfiguration element.

Example 8 may include the apparatus of example 1 and/or any other example herein, wherein a complete profile field of the multi-link reconfiguration element of the response frame is set to 1, and wherein a MAC address present field of the multi-link reconfiguration element of the response frame is set to 1.

Example 9 may include the apparatus of example 1 and/or any other example herein, wherein the multi-link reconfiguration element of the response frame comprises a station (STA) profile field with a capability information field as defined in an 802.11 association response frame, and a Status code field as defined in an 802.11 association response frame to indicate whether the communication link is accepted or rejected to be added, a supported rates and basic service set (BSS) membership selectors field as defined in the 802.11 association response frame, and elements that will be present if sent in the 802.11 association response frame, and wherein an inheritance rule of the elements is based on the elements in the first STA profile field in the multi-link reconfiguration element.

Example 10 may include the apparatus of example 1 and/or any other example herein, wherein the multi-link reconfiguration element of the response frame comprises KDE-related information for the communication link including multi-link operations (MLO) group temporal key (GTK) KDE, MLO integrity GTK (IGTK) KDE, and MLO beacon IGTK (BIGTK) KDE when the communication link has been added based on the request.

Example 11 may include the apparatus of example 1 and/or any other example herein, wherein for one or more communication links, comprising the communications link, that are accepted to added, by default all traffic identifiers (TIDs) mapped to the one or more communication links without additional negotiation, and wherein one or more non-AP stations (STAs) affiliated with the non-AP-MLD corresponding to the one or more communication links are in a power save (PS) mode and a doze state.

Example 12 may include the apparatus of example 1 and/or any other example herein, further comprising a transceiver configured to send and receive signals comprising the request frame and the response frame.

Example 13 may include the apparatus of example 12 and/or any other example herein, further comprising an antenna coupled to the transceiver to cause to send the request frame.

Example 14 may include a non-transitory computer-readable medium storing computer-executable instructions which when executed by one or more processors of an access point (AP) multi-link device (AP-MLD) result in performing operations comprising: identifying a request frame received from a non-AP-MLD, the request frame comprising a multi-link reconfiguration element indicative of a request to add or remove a communication link between the non-AP-MLD and an AP-MLD, the communication link previously used by the non-AP-MLD; encoding a response frame comprising the multi-link reconfiguration element and indicating whether the communication link was accepted or rejected to be added or removed; and causing the AP-MLD to transmit the response frame.

Example 15 may include the non-transitory computer-readable medium of example 14 and/or any other example herein, wherein the request frame and the response frame are protected 802.11 action frames comprising one or more key data encapsulation (KDE), and comprising a key data length field and a key data field, wherein the key data length field is indicative of a length of the key data field and the key data field includes the one or more KDE.

Example 16 may include the non-transitory computer-readable medium of example 14 and/or any other example herein, wherein the multi-link reconfiguration element of the request frame comprises a MLD capabilities and operations present field set to one in a presence bitmap.

Example 17 may include the non-transitory computer-readable medium of example 14 and/or any other example herein, wherein the multi-link reconfiguration element of the request frame comprises an enhanced multi-link (EML) capabilities present field set to 1 or 0.

Example 18 may include the non-transitory computer-readable medium of example 14 and/or any other example herein, wherein the multi-link reconfiguration element of the request frame comprises a non-simultaneous transmission reception (NSTR) link pair present in a STA control field and is set to 1.

Example 19 may include the non-transitory computer-readable medium of claim 14 and/or any other example herein, wherein the multi-link reconfiguration element of the request frame comprises a NSTR bitmap size field in a STA control field, wherein a complete profile field is set to 1, and wherein a medium access control (MAC) address present field is set to 1.

Example 20 may include a method for adding or removing affiliated access points (APs), the method comprising: identifying, by processing circuitry of a non-AP multi-link device (non-AP-MLD), a communication link between the non-AP-MLD and an AP-MLD, the communication link previously used by the non-AP-MLD; encoding, by the processing circuitry, a request frame comprising a multi-link reconfiguration element indicative of a request to add or remove the communication link; causing, by the processing circuitry, the non-AP-MLD to transmit the request frame to the AP-MLD; and identifying, by the processing circuitry, a response frame received from the AP-MLD, the response frame comprising the multi-link reconfiguration element and indicating whether the communication link was accepted or rejected to be added or removed.

Example 21 may include an apparatus comprising means for identifying a communication link between a non-AP-MLD and an AP-MLD, the communication link previously used by the non-AP-MLD; encoding a request frame comprising a multi-link reconfiguration element indicative of a request to add or remove the communication link; causing the non-AP-MLD to transmit the request frame to the AP-MLD; and identifying a response frame received from the AP-MLD, the response frame comprising the multi-link reconfiguration element and indicating whether the communication link was accepted or rejected to be added or removed.

Example 22 may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Example 23 may include an apparatus comprising logic, modules, and/or circuitry to perform one or more elements of a method described in or related to any of examples 1-21, or any other method or process described herein.

Example 24 may include a method, technique, or process as described in or related to any of examples 1-21, or portions or parts thereof.

Example 25 may include an apparatus comprising: one or more processors and one or more computer readable media comprising instructions that, when executed by the one or more processors, cause the one or more processors to perform the method, techniques, or process as described in or related to any of examples 1-21, or portions thereof.

Example 26 may include a method of communicating in a wireless network as shown and described herein.

Example 27 may include a system for providing wireless communication as shown and described herein.

Example 28 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. An apparatus of a non-access point (AP) multi-link device (non-AP-MLD) for adding or removing communication APs affiliated with an associated AP MLD, the non-AP-MLD comprising processing circuitry coupled to storage, the processing circuitry configured to:
identify a communication link between the non-AP-MLD and an AP-MLD, the communication link previously used by the non-AP-MLD;
encode a request frame comprising a multi-link reconfiguration element indicative of a request to add or remove the communication link;
cause the non-AP-MLD to transmit the request frame to the AP-MLD; and
identify a response frame received from the AP-MLD, the response frame comprising the multi-link reconfiguration element and indicating whether the communication link was accepted or rejected to be added or removed.

2. The apparatus of claim 1, wherein the request frame and the response frame are protected 802.11 action frames comprising one or more key data encapsulation (KDE), and comprising a key data length field and a key data field, wherein the key data length field is indicative of a length of the key data field and the key data field includes the one or more KDE.

3. The apparatus of claim 1, wherein the multi-link reconfiguration element of the request frame comprises a MLD capabilities and operations present field set to one in a presence bitmap.

4. The apparatus of claim 1, wherein the multi-link reconfiguration element of the request frame comprises an enhanced multi-link (EML) capabilities present field set to 1 or 0.

5. The apparatus of claim 1, wherein the multi-link reconfiguration element of the request frame comprises a non-simultaneous transmission reception (NSTR) link pair present in a STA control field and is set to 1.

6. The apparatus of claim 1, wherein the multi-link reconfiguration element of the request frame comprises a NSTR bitmap size field in a STA control field, wherein a complete profile field is set to 1, and wherein a medium access control (MAC) address present field is set to 1.

7. The apparatus of claim 1, wherein the multi-link reconfiguration element of the request frame comprises a station (STA) profile field comprising a capability information field as defined in an 802.11 association request frame, and elements that will be present if sent in an 802.11 association request frame, and wherein an inheritance rule of the elements is based on the elements in the first STA profile field in the multi-link reconfiguration element.

8. The apparatus of claim 1, wherein a complete profile field of the multi-link reconfiguration element of the response frame is set to 1, and wherein a MAC address present field of the multi-link reconfiguration element of the response frame is set to 1.

9. The apparatus of claim 1, wherein the multi-link reconfiguration element of the response frame comprises a station (STA) profile field with a capability information field as defined in an 802.11 association response frame, and a Status code field as defined in an 802.11 association response frame to indicate whether the communication link is accepted or rejected to be added, a supported rates and basic service set (BSS) membership selectors field as defined in the 802.11 association response frame, and elements that will be present if sent in the 802.11 association response frame, and wherein an inheritance rule of the elements is based on the elements in the first STA profile field in the multi-link reconfiguration element.

10. The apparatus of claim 1, wherein the multi-link reconfiguration element of the response frame comprises KDE-related information for the communication link including multi-link operations (MLO) group temporal key (GTK) KDE, MLO integrity GTK (IGTK) KDE, and MLO beacon IGTK (BIGTK) KDE when the communication link has been added based on the request.

11. The apparatus of claim 1, wherein for one or more communication links, comprising the communications link, that are accepted to added, by default all traffic identifiers (TIDs) mapped to the one or more communication links without additional negotiation, and wherein one or more non-AP stations (STAs) affiliated with the non-AP-MLD corresponding to the one or more communication links are in a power save (PS) mode and a doze state.

12. The apparatus of claim 1, further comprising a transceiver configured to transmit and receive signals comprising the request frame and the response frame.

13. The apparatus of claim 12, further comprising an antenna coupled to the transceiver to cause to send the request frame.

14. A non-transitory computer-readable medium storing computer-executable instructions which when executed by one or more processors of an access point (AP) multi-link device (AP-MLD) result in performing operations comprising:
identifying a request frame received from a non-AP-MLD, the request frame comprising a multi-link reconfiguration element indicative of a request to add or remove a communication link between the non-AP-MLD and an AP-MLD, the communication link previously used by the non-AP-MLD;
encoding a response frame comprising the multi-link reconfiguration element and indicating whether the communication link was accepted or rejected to be added or removed; and
causing the AP-MLD to transmit the response frame.

15. The non-transitory computer-readable medium of claim 14, wherein the request frame and the response frame are protected 802.11 action frames comprising one or more key data encapsulation (KDE), and comprising a key data length field and a key data field, wherein the key data length field is indicative of a length of the key data field and the key data field includes the one or more KDE.

16. The non-transitory computer-readable medium of claim 14, wherein the multi-link reconfiguration element of the request frame comprises a MLD capabilities and operations present field set to one in a presence bitmap.

17. The non-transitory computer-readable medium of claim 14, wherein the multi-link reconfiguration element of the request frame comprises an enhanced multi-link (EML) capabilities present field set to 1 or 0.

18. The non-transitory computer-readable medium of claim 14, wherein the multi-link reconfiguration element of the request frame comprises a non-simultaneous transmission reception (NSTR) link pair present in a STA control field and is set to 1.

19. The non-transitory computer-readable medium of claim 14, wherein the multi-link reconfiguration element of the request frame comprises a NSTR bitmap size field in a STA control field, wherein a complete profile field is set to 1, and wherein a medium access control (MAC) address present field is set to 1.

20. A method for adding or removing affiliated access points (APs), the method comprising:
identifying, by processing circuitry of a non-AP multi-link device (non-AP-MLD), a communication link between the non-AP-MLD and an AP-MLD, the communication link previously used by the non-AP-MLD;
encoding, by the processing circuitry, a request frame comprising a multi-link reconfiguration element indicative of a request to add or remove the communication link;
causing, by the processing circuitry, the non-AP-MLD to transmit the request frame to the AP-MLD; and
identifying, by the processing circuitry, a response frame received from the AP-MLD, the response frame comprising the multi-link reconfiguration element and indicating whether the communication link was accepted or rejected to be added or removed.
